(19) United States
(12) Patent Application Publication
(10) Pub. No.: US 2009/0313163 A1
(43) Pub. Date: Dec. 17, 2009

(54) Credit line optimization

(76) Inventors: Ming-huan Wang, Manhasset, NY (US); Feng Zhao, Harrison, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/011,651

(22) Filed: Dec. 14, 2004

Related U.S. Application Data
(60) Provisional application No. 60/544,471, filed on Feb. 13, 2004.
(60) Provisional application No. 60/568,521, filed on May 6, 2004.

(51) Int. Cl. G06Q 40/00; G06N 5/02

(52) U.S. Cl. 705/38; 706/52

(57) ABSTRACT

In a system for assigning a credit line to a credit card application, the system receives a plurality of credit card applications each having applicant information. For each application, the system retrieves credit bureau information. The applicant information and the credit bureau information are used to model the likely behavior of the corresponding applicant. The applications are clustered into one or more clusters according to the modeled behavior. For each cluster of applications, financial measures are forecasted and analyzed to determine the optimal credit line to assign to the cluster.

### CROSS-REFERENCE TO RELATED APPLICATIONS

This application claims the benefit of U.S. Provisional Application No. 60/544,471 and U.S. Provisional Patent Application No. 60/568,521, both by Ming-huan Wang and Feng Zhao and both entitled “Credit Line Optimization”, filed on Feb. 13, 2004 and May 6, 2004, respectively. The entire disclosures of U.S. Provisional Application No. 60/544,471 and U.S. Provisional Patent Application No. 60/568,521 are hereby incorporated herein by reference.

### FIELD OF THE INVENTION

The present invention relates to a method and a system for assigning an optimized credit line to a credit card application.

### BACKGROUND OF THE INVENTION

Credit card applications submitted by an applicant to a credit issuer are evaluated to determine the appropriate credit line to assign to each approved credit card application. Conventional methods used by credit issuers in assigning a credit line typically involve the evaluation of two primary factors: character and capacity. An applicant's “character” is generally measured by the applicant's credit score, such as, for example, the Fair Isaac & Co. Credit (FICO) score as determined by one or more of the three primary credit bureaus (Experian, Trans Union and Equifax).

An applicant's “capacity” is a measure of the loan size or amount of credit the applicant is capable of handling, and usually is based primarily on the applicant's income as stated in the credit card application. Generally, the higher the applicant's stated income, the larger the amount of credit that may be extended by the credit issuer.

Thus, this conventional credit-line assignment methodology is based heavily on two factors: the applicant's stated income and the applicant's FICO score. According to this approach, applicants having a higher income and/or a higher credit bureau score receive higher credit line amounts. However, this approach fails to consider the applicant's credit needs and does not provide the credit issuer with the ability to incorporate important business objectives and constraints into the credit-line assignment analysis.

Furthermore, the integrity of the two primary sources of information upon which the credit-line assignment decision is predicated is questionable. The applicant's income is self-reported and lacks verification of its accuracy. In addition, FICO scores generated by the credit bureaus often include errors and credit events improperly associated with the applicant (e.g., instances wherein the applicant shares the same name with another and the other's credit event wrongly appears on the applicant's credit report).

The assignment of credit line amounts to credit card applications impacts both the revenue and the credit quality of the credit issuer's credit card portfolio. Assignment of low credit line amounts relative to competing credit issuers may result in diminished card usage and less revenue for the issuer. Likewise, an excessively high credit line amount exposes the issuer to a higher risk of loan loss in the case of a default.

Accordingly there is a need in the art for a method and a system for efficiently assigning a credit line to a credit card application based on the optimization of multiple financial objectives and constraints.

### SUMMARY OF THE INVENTION

The present invention relates to a method and a system for assigning an optimized credit line to a credit card application.

According to an embodiment of the invention, the method and the system identifies a credit line to assign to a credit card application by modeling the behavior of the applicant in order to group like applicants into homogeneous clusters; determines one or more financial measures on a cluster-by-cluster basis; and assigns a credit line to each cluster based on a constrained optimization analysis of the financial measures.

According to an embodiment of the invention, a credit line optimization system receives a plurality of credit card applications from a plurality of applicants. For each application, the system uses application information from the application to retrieve credit bureau information related to the applicant.

The application information and the credit bureau information, collectively referred to as “predictive variables,” are used to model the predicted behavior of the applicant. Specifically, behavior modeling is used to predict an applicant's likely behavior with respect the credit card, such as the applicant's risk level and credit card usage patterns. In a preferred embodiment, the modeling is focused on behavior related specifically to credit line assignment.

Each behavioral category modeled is represented by one or more prediction values. For example, the prediction values can include but are not limited to the predicted account balance the applicant will maintain on his or her credit card, the predicted revenue the credit issuer will realize from this applicant, and the predicted sales.

Applications having similar prediction values are grouped into homogeneous clusters according to known clustering techniques. For each cluster, a number of financial measures are calculated based on the prediction values. Exemplary financial measures include but are not limited to loan loss rate (LLR), risk adjusted margin (RAM), return on asset (ROA), shareholder valued added (SVA), net income before tax (NIBT), operating net income (ONI), etc.

Advantageously, based on the specific financial goals of the credit issuer, one or more of the financial measures may be set as either a financial “objective” or a financial “constraint.” Applying a constrained optimization analysis, a credit line that optimizes the objectives while meeting the constraints.

### BRIEF DESCRIPTION OF THE DRAWINGS

The present invention will be more readily understood from the detailed description of the preferred embodiment(s) presented below considered in conjunction with the attached drawings, of which:

FIG. 1 is a schematic diagram of a credit-line optimization system, according to an embodiment of the present invention; and

FIG. 2 is a diagram illustrating a process flow, according to an embodiment of the invention.

It is to be understood that the attached drawings are for the purpose of illustrating concepts of the present invention and may not be to scale.

### DETAILED DESCRIPTION OF THE PREFERRED EMBODIMENTS

The present invention relates to a method and a system for assigning an optimized credit line to credit card applications based on behavior modeling, clustering of like applications into homogeneous clusters, deriving cluster-specific financial measures, and assigning a credit line based on analysis of the financial measures.

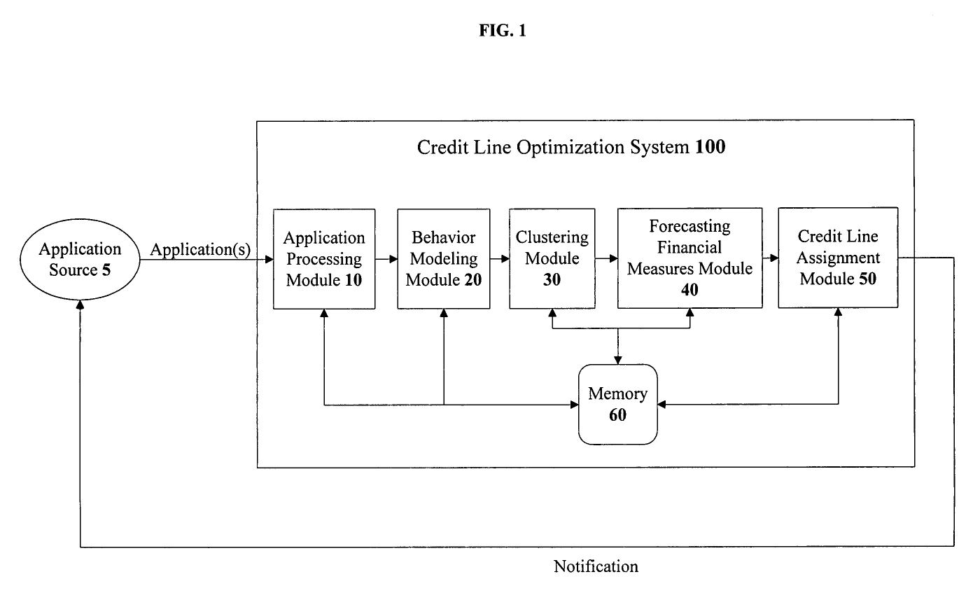

FIG. 1 illustrates an exemplary Credit Line Optimization System 100 for assigning an optimal credit line to a plurality of credit card applications. In a preferred embodiment, the System 100 includes one or more computers communicatively connected to a source of credit card applications, referred to as an Application Source 5. The term “computer” is intended to include any data processing device, such as a desktop computer, a laptop computer, a mainframe computer, a personal digital assistant, a server, or any other device able to process data. The term “communicatively connected” is intended to include any type of connection, whether wired or wireless, in which data may be communicated. The term “communicatively connected” is intended to include a connection between devices within a single computer or between devices on separate computers.

One of ordinary skill in the art will appreciate that the Application Source 5 may be any source of credit card applications including but not limited to individual credit card applicants. In a preferred embodiment, the Application Source 5 is a computer-readable memory storing new credit card applications submitted by applicants via any known method, including but not limited to submissions via a Web-based network, such as, the Internet.

Each application includes information about the applicant, referred to as “application information.” Typically, the application information is provided by the applicant as requested on the application. The application information may include, but is not limited to, the applicant's name, street address, social security number, employment status, employer name, annual salary, financial data, a balance transfer request amount, credit history data and marital status. One of ordinary skill in the art will appreciate that the application information may already be available to the credit issuer for a pre-selected applicant.

An Application Processing Module 10 receives the plurality of applications, and optionally performs a preliminary review of each application to determine if the necessary application information has been provided. Using the application information, the Application Processing Module 10 retrieves information from one or more of the known credit bureaus, referred to as the applicant's “credit bureau information.” The credit bureau information may include, but is not limited to, the length of the applicant's credit history, the number of reported credit applications filed by the applicant, the total credit card balance maintained by the applicant, the delinquency record of the applicant, the total number of derogatory ratings, the applicant's bank card utilization (the percentage of the ratio of balance to limit on revolving and national applications), the revolving balance acceleration and/or the applicant's FICO score as determined by one or more of the three primary credit bureaus (Experian, Trans Union and Equifax).

The Application Processing Module 10 provides the application information and the credit bureau information to a communicatively connected Behavior Modeling Module 20.

The Behavior Modeling Module 20 models the behavior of the applicant to predict, for example, the applicant's risk level and credit card usage patterns, as described in detail below. A Cluster Module 30 clusters applications based on the modeled behavior, as described in detail below. For each cluster formed by the Cluster Module 30, a Forecast Financial Measures Module 40 predicts or forecasts additional credit-card-related financial measures, known in the art, based on the characteristics of the applicants in the cluster, as described in detail below. Using these cluster-specific forecasted financial measures, a Credit Line Assignment Module 50 assigns an optimal credit line to each cluster, as described in detail below. In a preferred embodiment, the System 100 transmits a notification of the assigned credit line to the applicant.

One of ordinary skill in the art will appreciate that the Modules 10, 20, 30, 40, 50 may be one or more computers programmed to perform the described functions.

In a preferred embodiment, the Modules 10, 20, 30, 40, 50 of the System 100 include computer-implementable software code implemented by one or more computers. According to this embodiment, the System 100 includes one or more computers programmed to implement the Modules 10, 20, 30, 40, 50. Optionally, one of ordinary skill in the art will appreciate that the Modules 10, 20, 30, 40, 50 may each be any number of steps manually implemented by one or more persons. Optionally, the System 100 may be implemented by a combination of one or more computers and one or more persons.

Preferably, a Memory 60, such as, for example, a computer-readable memory, is communicatively connected to the Modules 10, 20, 30, 40, 50 of the System 100 for storing information inputted to and outputted by the Modules 10, 20, 30, 40, 50. One of ordinary skill in the art will appreciate that each Module 10, 20, 30, 40, 50 may be communicatively connected to a separate Memory 60 or that all of the Modules 10, 20, 30, 40, 50 may be communicatively connected to a single Memory 60. Optionally, the Memory 60 may reside on the one or more computers of the System 100 or reside on a separate, communicatively connected computer or computers.

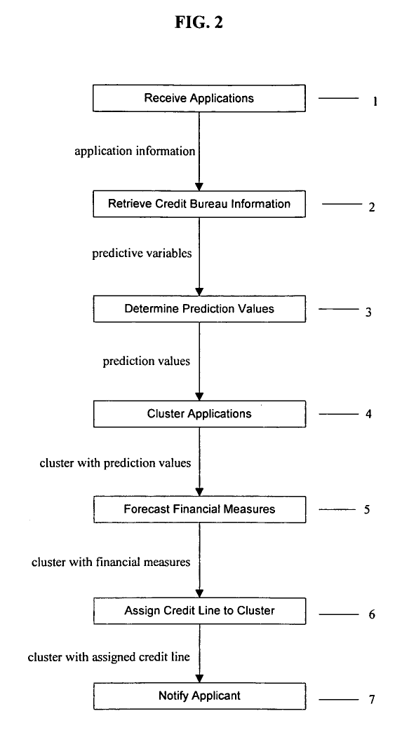

FIG. 2 illustrates an exemplary process flow of a credit-line optimization method according to an embodiment of the invention. It is to be understood that the schematic representation provided in FIG. 2 is exemplary in nature and alternative arrangements are within the scope of the invention.

In step 1, a credit issuer receives a plurality of credit card applications having application information from a plurality of credit card applicants.

In step 2, using the application information, the credit issuer requests and captures the credit bureau information. Collectively, the application information and the credit bureau information define a number of “predictive variables,” which are used to predict or model the applicant's likely credit-card-related behavior, as described in detail below.

In step 3, the applicant's credit-card-related behavior is predicted using any known behavior modeling technique. The models, which are customizable based on the different financial products offered by the credit issuer, are used to determine one or more behavior “prediction values.” The prediction values are determined by the models based on the analysis of one or more of the predictive variables. One of ordinary skill in the art will appreciate that the predictive variables selected to determine the one or more prediction value depends on the behavior model employed.

In a preferred embodiment, behavioral models are built to generate one or more selected prediction values desired by the credit issuer. Advantageously, the models are built based on behavioral factors related specifically to credit line assignment. These models are referred to as “credit line assignment models” because they are directed to modeling behavior associated with factors related specifically to credit line assignment.

Exemplary credit line assignment models include but are not limited to: 1) a Unit Loss Rate Model; 2) a Balance Sensitivity Model; 3) a Revenue Sensitivity Model; and 4) a Sales Sensitivity Model.

The Unit Loss Rate Model provides a prediction value for a probability that the applicant will default within a predetermined period of time, i.e., the risk level. An account “default” may include, but is not limited to, a charge-off or bankruptcy filing by the applicant. Preferably, the predetermined period of time is less than or equal to 18 months.

A logistic regression technique, known in the art, may be used to build the Unit Loss Rate Model. Applying an exemplary logistic regression technique, the probability of default (p) by the applicant is expressed according to the following equation:

p=exp(log odds)/(1+exp(log odds)). Equation 1

For example, the probability of default (the prediction value) can be calculated as a linear function of two predictive variables: the total bankcard balance and the total number of derogatory ratings. Assume, for this example, an applicant has a total credit card balance of $3000 and a total number of derogatory ratings of 2. The log odds for these two predictive variables may be calculated using the following equation:

log odds=−4+(0.0001*total credit card balance)+(0.3*total number of derogatory ratings).

Thus, in this example, log odds=−4+(0.0001*3000)+(0.3*2)=−3.1. Substituting the calculated log odds value into Equation 1 results in:

p=exp(−3.1)/(1−exp(−3.1))=0.043.

Thus, based on the predictive variables (total credit card balance and number of derogatory ratings), the Unit Loss Rate Model predicts that this applicant presents a 4.3% probability of default.

Other exemplary credit-line assignment models suitable for use in the present invention include Sensitivity Models based on balance, revenue, and sales. The Balance Sensitivity Model determines a prediction value for a balance that the applicant will maintain during the period of each of a plurality of credit line options. The Revenue Sensitivity Model determines a prediction value for the revenue that the applicant will generate for the credit issuer during the period of each of the credit line options. The Sales Sensitivity Model determines a prediction value for the dollar amount of purchases made by the applicant during a period for each of the credit line options. Optionally, the behavior models may be reviewed and modified from time to time based on the performance of the models.

One having ordinary skill in the art will appreciate that these Sensitivity Models may be built using known modeling technique, such as, for example, Chi-square Automatic Interaction Detection (CHAID) tree modeling, scorecard modeling, or neural network modeling. In a preferred embodiment, CHAID tree modeling is used to split the entire population of applications into a number of sub-groups, referred to as nodes, based on the applications' predictive variables. The nodes are defined according to historical data for existing accounts. Optionally the historical data may be stored in a computer-readable memory, such as Memory 60. The historical data may include but is not limited to the predictive variables of the existing accounts.

A significance test known in the art, such as for example the Chi-squared test, selects which predictive variables to use and determines where to split the selected predictive variables into nodes. For applications in each node, the CHAID tree determines a prediction value for the dependent variable (i.e., balance, revenue, or sales).

For example, a credit issuer may seek to determine the predicted balance in the event a $6000 credit line is assigned to an applicant having a reported income of $70,000 and two existing credit cards. A Balance Sensitivity Model according to the CHAID tree modeling technique is applied to predict the balance.

In this example, the nodes of the Balance Sensitivity Model are built on existing accounts receiving a credit line in the range of $6000 (i.e., between $5500 and $6500) using two predictive variables: reported income and total number of credit cards. The predicted balance of each node is the average balance of the existing accounts used to define the node. The two variables produce a 4-node CHAID tree represented in Table 1.

TABLE 1

| | Reported annual | Number of | |
|---|---|---|---|
| Node | income | credit cards | Predicted Balance |
| 1 | <$50,000 | <3 | $2200 |
| 2 | <$50,000 | ≧4 | $1800 |
| 3 | ≧$50,000 | <3 | $3100 |
| 4 | ≧$50,000 | ≧4 | $2700 |

Accordingly, an applicant having a reported income of $70,000 and two credit cards would be associated with Node 3 and have a predicted balance of $3100 if a credit line of $6000 is assigned.

One of ordinary skill in the art will readily appreciated that this type of modeling may be used to build other sensitivity models, including but not limited to revenue sensitivity models and sales sensitivity models.

In step 4, applicants are grouped into homogeneous clusters based on the prediction values generated by the behavior modeling in step 3. In a preferred embodiment, the clusters are defined by any one or more prediction values, as selected by the credit issuer. Optionally, other financial measures, described in detail below, may be used as clustering filters to form the clusters.

One having ordinary skill in the art will readily appreciate that other attributes relevant to the assignment of a credit line may be used as clustering filters to define the clusters. For example, the clustering determination may be based on the predictive variables (application information and credit bureau information), existing lifestyle models, or other information deemed important by the credit issuer, such as, for example, the applicant's highest assigned credit line or the balance transfer request amount.

In a preferred embodiment of the present invention, the applicants are clustered using a known cluster analysis technique. Advantageously, the cluster analysis technique allows for the creation of homogeneous clusters based on any number of prediction values, wherein applicants having similar prediction values are grouped together. According to this embodiment, the cluster analysis computes a value, referred to as an “observation value,” for each application. The observation value is a function of the two or more prediction values or other attributes. The observation value of each application is used to group the application into the appropriate cluster of similar applications.

For example, a credit issuer may have eight (8) candidate credit lines to chose from in assigning the appropriate credit line to each cluster. In this example, one (1) unit loss rate model, eight (8) revenue sensitivity models, eight (8) balance sensitivity models, and eight (8) sales sensitivity models are built. As such, twenty five (25) prediction values are calculated and used to generate an observation value for each application. Thus, the observation value for each applicant represents a single point in a 25-dimensional space.

Applying cluster analysis, points in the 25-dimensional space are determined are referred to as “cluster centers.” The distance between each of these cluster centers and an applicant's observation value is computed. The application is then assigned to the nearest cluster (i.e., the cluster having the cluster center nearest to the application's observation value).

For each cluster formed in step 4, one or more additional financial measures are forecasted. Advantageously, these financial measures are computed based upon one or more of the prediction values. The financial measures, derived as a function of the prediction values, include but are not limited to expected revenue, loan loss rate (LLR), risk adjusted margin (RAM), return on asset (ROA), shareholder valued added (SVA), net income before tax (NIBT), operating net income (ONI), etc. These financial measures and others suitable for use in the present invention are well known in the art. Preferably, the financial measures are computed on a cluster-by-cluster basis.

An exemplary financial measure, LLR, defined as the total loss as a percentage of total balance, may be computed according to an embodiment of the invention using the following expression:

LLR=(p*credit line)/balance,

where “p” is the average of all loss rate prediction values for all applicants in a cluster; “balance” is the average of the balance sensitivity prediction values for all applications in a cluster; and
“credit line” is the assigned credit line amount selected from the candidate credit lines.

Another exemplary financial measure, RAM, may be computed according to an embodiment of the invention using the following expression:

RAM=(((1−p)*revenue)−(p*credit line))*number of applicants,

where “number of applicants” is the total number of applicants in the cluster.

According to another embodiment of the current invention, RAM, can be computed using the following expression:

RAM=((1−p)*revenue)−((p*credit line)/balance).

Another exemplary financial measure, NIBT, defined as total revenue minus total loan loss minus the operating cost, may be computed according to an embodiment of the invention using the following expression:

NIBT=(((1−p)*revenue)−(p*credit line-operating cost))*number of applicants,

where “operating cost” is a constant based on historical data.

According to an embodiment of the invention, ONI, may be computed using the following expression:

ONI=(1−tax rate)*NIBT,

where “tax rate” is a constant based on historical data of existing accounts in a similar cluster.

Another exemplary financial measure, ROA, may be computed using the following expression:

ROA=ONI/total balance

where “total balance” is the sum of the prediction values for the balances of the applications in a cluster.

Another exemplary financial measure, SVA, may be computed using either of the following expressions:

SVA=NIBT−cost of capital allocation; or

SVA=NIBT−(total balance*capital allocation rate*hurdle return rate),

where “capital allocation rate” and “hurdle return rate” are constants based on historical data of accounts in a similar cluster.

In step 6, the system determines the optimal credit line to assign to each cluster using a mathematical analysis of one or more of the financial measures computed in step 5. According to an embodiment of the invention, the decision of whether a credit line option is optimal for a particular cluster based on the objectives and constraints is represented by a decision variable “x”. Specifically, a decision variable x(k,l) is created for each cluster (indexed by k) and each candidate credit line (indexed by l). For example, if there are 8 candidate credit lines (l=8) and 50 clusters (k=50), then there are 8*50=400 decision variables.

There are restrictions on the value of the decision variables. For example, only one credit line can be assigned to each cluster. In addition, other optional limits may be placed on the decision variables, including but not limited to setting a total exposure limit or loan loss rate.

In an embodiment of the present invention, a credit line is assigned to each cluster according to the well known Full Search approach. According to the Full Search approach, the credit issuer selects a respective credit line from the credit line options “l” to assign to each cluster of “k” clusters. According to the Full Search approach, all possible combinations of the “l” and “k” variables are explored until the optimal solution is determined. Generally, the Full Search approach requires approximately l^{k} iterations to determine the appropriate credit line option. As such, the Full Search approach is not preferred when the number of candidate credit lines (l) and/or the number of clusters (k) is large.

According to a preferred embodiment, to determine the optimal credit line, the credit issuer selects one or more financial measures as either an “objective” or a “constraint.” Which financial measures to select as objectives and constraints depends on the particular portfolio at issue. For example, the issuer may determine that it would like to maximize the loan loss level by 5% (the objective), while maintaining the existing ROA (the constraint).

Each of the objectives and constraints are represented as a function of the decision variables. The decision variable xₖₗ has a value of “1” or unity when it is the appropriate selection in light of the objectives and constraints, or “0” or zero when it is not appropriate. Because the decision variables may only take a value of either “0” or “1”, a well known type of mathematical analysis employed to solve for the decision variable xₖₗ is referred to as a Binary Programming analysis.

According to the invention, a Branch-Bound algorithm, known in the art, is applied to optimize the decision variables when the objectives and constraints are both linear functions of the decision variables and integer solutions are required. In a preferred embodiment, the Branch Bound algorithm is implemented by a computer. More preferably, the Branch Bound algorithm is implemented by the SAS/OR® computer processing platform manufactured by the SAS Institute (100 SAS Campus Drive, Cary, N.C. 27513-2414).

The Branch-Bound algorithm converts a binary programming problem into a series of linear programming problems. Generally, the Branch-Bound algorithm defines the objectives and constraints in the form of “maximize X, subject to Y”, wherein X is the objective and Y is the constraint. Exemplary optimization scenarios include but are not limited to “maximizing ROA/SVA, subject to loan loss rate and/or exposure constraints” and “maximize RAM/ROA, subject to SVA and loan loss rate constraints.” Optionally, multiple objectives subject to multiple constraints may be optimized simultaneously, with the multiple objectives having a predetermined order of priority.

The following is an exemplary application of the Branch-Bound algorithm to determine the optimal credit line in view of selected objectives and constraints. In this example, the credit issuer seeks to determine which credit line, when assigned to a particular cluster, will meet the financial objective of maximizing RAM while limiting the loan loss rate to 7%, subject to the condition of requiring the applicants in the cluster to maintain an average credit line of ≦4000. Applying the Branch-Bound algorithm results in the following expression:

$$\begin{matrix}Maximize \text{:} {\sum }_{k = 1}^{K} {\sum }_{l = 1}^{L} ( {R}_{kl} - {C}_{l} {P}_{k} ) {n}_{k} {x}_{kl} \\ Subject to \text{:} {\sum }_{k = 1}^{K} {\sum }_{l = 1}^{L} ( {C}_{l} {P}_{k} - 0.07 {B}_{kl} ) {n}_{k} {x}_{kl} = 0 ; \\ {\sum }_{k = 1}^{K} {\sum }_{l = 1}^{L} {C}_{l} {x}_{kl} \leq 4000 \sum {n}_{k} ; \\ {\sum }_{l = 1}^{L} {x}_{kl} = 1 ;\end{matrix}$$

$$\begin{matrix}0 \leq {x}_{kl} \leq 1 & ( in iteration 1 of i ) ; and \\ 0 \leq {x}_{kl} \leq {x}_{kl}^{( i - 1 )} or {x}_{kl}^{( i - 1 )} \leq {x}_{kl} \leq 1 & ( in iteration i ) ,\end{matrix}$$

where x is the credit line decision variable;
k is the index of the 35 clusters;
l is the index of the 7 candidate credit lines;
C is the credit line amount;
nₖ is total number of applicants in the cluster in the k^{th} cluster;
i is the number of iterations used to solve the Branch Bound algorithm;
R is the predicted revenue;
B is the predicted balance; and
P is the predicted unit bad rate.

In another embodiment of the present invention, non-linear functions of the decision variables, such as ROA and LLR, are determined using a conversion algorithm. The conversion algorithm converts the non-linear objectives into a series of problems, each with linear objectives that can be solved using the Branch-Bound algorithm to convert non-linear objective/constraint functions into linear form. In a preferred embodiment, the conversion algorithm is implemented by a computer.

The following is an exemplary application of the conversion algorithm for assigning a credit line wherein the credit issuer seeks to maximize ROA (a non-linear function) subject to the loan loss rate and exposure constraints. The conversion algorithm described above is applied to convert the ROA expression, which is a non-linear objective function, to a linear objective function, resulting in an expression for ROA in terms of linear functions, as in:

ROA=ONI/total balance.

Substituting linear functions of xₖₗ, namely A(xₖₗ) and B(xₖₗ), for ONI and total balance, respectively, results in an expression that converts the non-linear functions into linear functions. Thus, the converted expression for solution of the exemplary problem according to known methods in the art is:

$${Maximize}_{b} \text{:} \{ {Maximize}_{{x}_{kl}} \text{:} A ( {x}_{kl} ) / b , \\ Subject to \text{:} B ( {x}_{kl} ) = b ; \\ loan loss rate constraint ; and \\ exposure constraint \} ,$$

where b is a selected value for the balance.

Although the present invention has been described in considerable detail with reference to certain preferred embodiments and version, other versions and embodiments are possible. Therefore, the scope of the present invention is not limited to the description of the versions and embodiments expressly disclosed herein. The references and disclosure provided in the ‘Background of the Invention’ section are not admitted to be prior art with respect to the disclosure provided in the present application.

1. A method for assigning a credit line to a credit card application, the method comprising the steps of:
receiving a plurality of credit card applications each having application information from an applicant;
retrieving credit bureau information for each of the plurality of credit card applications;
for each of the plurality of credit card applications, modeling applicant behavior by determining for each application a predicted account balance to be maintained by the applicant, a predicted revenue to be generated for a credit issuer by the applicant, a predicted amount of purchases to be made by the applicant, and a unit loss rate to predict a probability of default by the applicant, based at least in part on application information and credit bureau information;
generating an observation value for each credit card application based at least in part on the predicted account balance, the predicted revenue, the predicted amount of purchases, and the unit loss rate, and assigning each credit card application to a cluster based at least in part on the observation value for each credit card application;
deriving one or more financial measures for each cluster based at least in part on the predicted account balance, the predicted revenue, the predicted amount of purchases, and the unit loss rate; and
assigning a credit line to each cluster based at least in part on the one or more financial measures, wherein the credit line is assigned to each credit card application in a given cluster.

2. (canceled)

3. The method of claim 1, wherein the step of clustering is performed using a cluster analysis technique.

4. (canceled)

5. (canceled)

6. The method of claim 1, wherein the step of assigning includes selecting one or more objectives and one or more constraints from the one or more financial measures.

7. The method of claim 6, wherein the step of assigning the credit line includes maximizing the one or more objectives subject to the one or more constraints.

8. The method of claim 7, wherein the step of assigning the credit line includes using a branch bound algorithm.

9. The method of claim 1, further comprising the step of notifying an applicant of a credit line assignment.

10-18. (canceled)

19. A computer-implemented method for assigning a credit line to a credit card application, the method comprising the steps of:
receiving a plurality of credit card applications each having application information from an applicant;
retrieving credit bureau information for each of the plurality of credit card applications;
for each of the plurality of credit card applications, modeling applicant behavior by determining for each application a predicted account balance to be maintained by the applicant, a predicted revenue for a credit issuer to be generated by the applicant, a predicted amount of purchases to be made by the applicant, and a unit loss rate to predict a probability of default by the applicant, based at least in part on application information and credit bureau information;
generating an observation value for each credit card application based at least in part on the predicted account balance, the predicted revenue, the predicted amount of purchases, and the unit loss rate, and assigning each credit card application to a cluster based at least in part on the observation value for each credit card application;
deriving one or more financial measures for each cluster based at least in part on the predicted account balance, the predicted revenue, the predicted amount of purchases, and the unit loss rate; and
assigning a credit line to each cluster based at least in part on the one or more financial measures, wherein the credit line is assigned to each credit card application in a given cluster.

20. (canceled)

21. The method of claim 19, wherein the step of clustering is performed using a cluster analysis technique.

22. (canceled)

23. (canceled)

24. The method of claim 19, wherein the step of assigning the credit line includes selecting one or more objectives and one or more constraints from the one or more financial measures.

25. The method of claim 24, wherein the step of assigning the credit line includes maximizing the one or more objectives subject to the one or more constraints.

26. A computer-readable storage medium storing computer code for implementing a method of assigning a credit line to a credit card application, wherein the computer code comprises:
code for receiving a plurality of credit card applications each having application information from an applicant;
code for retrieving credit bureau information for each of the plurality of credit card applications;
code for, for each of the plurality of credit card applications, modeling applicant behavior by determining for each application a predicted account balance to be maintained by the applicant, a predicted revenue to be generated for a credit issuer by the applicant, a predicted amount of purchases to be made by the applicant, and a unit loss rate to predict a probability of default by the applicant, based at least in part on application information and credit bureau information;
code for generating an observation value for each credit card application based at least in part on the predicted account balance, the predicted revenue, the predicted amount of purchases, and the unit loss rate, and assigning each credit card application to a cluster based at least in part on the observation value for each credit card application; code for deriving one or more financial measures for each cluster based at least in part on the predicted account balance, the predicted revenue, the predicted amount of purchases, and the unit loss rate; and
code for assigning a credit line to each cluster based at least in part on the one or more financial measures, wherein the credit line is assigned to each credit card application in a given cluster.

27. A computer-implemented method for assigning a credit line to a credit card application, the method comprising the steps of:
receiving a plurality of credit card applications each having application information;
retrieving credit bureau information for each of the plurality of credit card applications;
for each credit card application, modeling applicant behavior with respect to a credit line assignment by determining for each application a predicted account balance to be maintained by the applicant, a predicted revenue to be generated for a credit issuer by the applicant, a predicted amount of purchases to be made by the applicant, and a unit loss rate to predict a probability of default by the applicant, based at least in part on application information and credit bureau information;
clustering the plurality of credit card applications into one or more clusters using a cluster analysis technique to generate an observation value for each credit card application based at least in part on predicted account balance, the predicted revenue, the predicted amount of purchases, and the unit loss rate and to respectively assign each credit card application to a cluster based at least in part on a corresponding observation value for each credit card application;
deriving one or more financial measures for each cluster based at least in part on the predicted account balance, the predicted revenue, the predicted amount of purchases, and the unit loss rate; and
assigning a credit line to each cluster by selecting one or more objectives and one or more constraints from the one or more financial measures, and maximizing the one or more objectives subject to the one or more constraints, wherein the credit line is assigned to each credit card application in a given cluster.

28. A system for assigning a credit line to a credit card application, the system comprising:
an application processing module communicatively connected to a credit card application source, wherein the application processing module receives a plurality of credit card applications each having application information and retrieves credit bureau information for each of the plurality of credit card applications;
a behavior modeling module communicatively connected to the application processing module, wherein for each credit card application, the behavior modeling module models applicant behavior with respect to a credit line assignment by determining for each application a predicted account balance to be maintained by an applicant, a predicted revenue to be generated for the credit issuer by the applicant, a predicted amount of purchases to be made by the applicant, and a unit loss rate to predict a probability of default by the applicant, based at least in part on application information and credit bureau information;
a clustering module communicatively connected to the behavior modeling module, wherein the clustering module clusters the plurality of credit card applications into one or more clusters using a cluster analysis technique to generate an observation value for each credit card application based at least in part on the predicted account balance, the predicted revenue, the predicted amount of purchases, and the unit loss rate and to assign each credit card application respectively to a cluster based at least in part on a corresponding observation value for each credit card application;
a forecasting financial measures module communicatively connected to the clustering module, wherein the forecasting financial measures module derives one or more financial measures for each cluster based at least in part on the predicted account balance, the predicted revenue, the predicted amount of purchases, and the unit loss rate; and
a credit line assignment module communicatively connected to the forecasting financial measures module, wherein the credit line assignment module assigns a credit line to each cluster based at least in part on the one or more financial measures, wherein the credit line is assigned to each credit card application in a given cluster.

29. The system according to claim 28, wherein the credit line assignment module selects one or more objectives and one or more constraints from the one or more financial measures.

30. The system according to claim 29, wherein the credit line assignment module maximizes the one or more objectives subject to the one or more constraints.

31. The system according to claim 30, wherein the credit line assignment module maximizes the one or more objectives subject to the one or more constraints using a branch bound algorithm.

32. The system according to claim 28, wherein the credit line assignment module notifies an applicant of a credit line assignment.
